(19) United States
(12) Patent Application Publication
(10) Pub. No.: US 2025/0298772 A1
(43) Pub. Date: Sep. 25, 2025

(54) COMPUTER ARCHITECTURE 3D BUS INTERRUPT

(71) Applicant: ICAT, LLC d/b/a Turing Micro, Terre Haute, IN (US)

(72) Inventor: George Jeffrey Bennett, Murrieta, CA (US)

(73) Assignee: ICAT, LLC d/b/a Turing Micro, Terre Haute, IN (US)

(21) Appl. No.: 19/085,783

(22) Filed: Mar. 20, 2025

Related U.S. Application Data
(60) Provisional application No. 63/567,810, filed on Mar. 20, 2024.

(51) Int. Cl. G06F 15/78; G06F 15/173

(52) U.S. Cl. CPC G06F 15/7875; G06F 15/17325

(57) ABSTRACT

A multiple CPU pseudo 3D structure is provided that allows single clock cycle interrupt latency, requires no context storage while taking only a single cycle away from normal programs. Multiple interrupts are given flexible vectored parallel computing responses without timing interactions.

### BACKGROUND

There is a continuing need in all types of multi-CPU computing for better flexibility in functional partitioning and mapping, handling the computing context, and decreasing latency and overhead when an interrupt occurs. Faster CPU interrupt response times reduce the need for custom hardware-based solutions in high performance computing.

### SUMMARY

Embodiments of the present invention provide multiple simplified CPUs while eliminating complex interrupt structures and having single clock cycle response latency with full vectored interrupt capability, while taking minimal cycles from the main computing sequences. Various embodiments to achieve such goals are provided herein.

Embodiments of the present invention may have various features and provide various advantages. Any of the features and advantages of the present invention may be desired, but are not necessarily required to practice the present invention.

### BRIEF DESCRIPTION OF THE DRAWINGS

FIG. 1 illustrates a diagram of a 2 dimensional layout of computing RAPCs with intervening buses and switches according to an embodiment.

FIG. 2 illustrates a diagram of interconnects between adjacent RAPCs, according to an embodiment.

FIG. 3 illustrates a diagram of a virtual 3D programming model, according to an embodiment.

FIG. 4 illustrates a diagram of data flow within the virtual 3D model, according to an embodiment.

FIG. 5 illustrates a diagram of how the 3D multi-layer model is created using a single RAPC, according to an embodiment.

FIG. 6 illustrates a diagram of Z axis branching and adjacent path usage, according to an embodiment.

FIG. 7 illustrates a diagram of a RAPC configured for I/O operations, according to an embodiment.

FIG. 8 illustrates a diagram of the initial interrupt arrangement in 3D, according to an embodiment.

FIG. 9 illustrates a diagram of an initial interrupt response, according to an embodiment.

FIG. 10 illustrates a diagram of the interrupt creating computational space in the data flow, according to an embodiment.

FIGS. 11A, 11B, 11C and 11D illustrate a diagram of successive data flow operations, according to an embodiment.

FIG. 12 illustrates a diagram of the setup for dual interrupts, according to an embodiment.

### DETAILED DESCRIPTION

The present application relates to interrupts, inputs to a computing device that disrupt the normal execution of a program to deal with an out of sequence event.

### Real Time Computing

Real time computing is one class of application in which interrupts are highly important. Real time computing demands that computations be done within strict time requirements (deadlines), usually externally determined. If deadlines are exceeded, severe impact or failure of a system in which the CPU resides will occur. This conflicts with most CPUs that are designed optimally for internal operations; such designs are described as CPU-centric. More complex CPUs are usually more CPU-centric. Any time a CPU is shared between multiple or unrelated tasks (multi-tasking) as in real time computing, many conflicting requirements are created. Several programs (here called threads) must run in an orderly fashion without interfering with each other. Computing threads use common resources that must be shared in an orderly manner; the danger of conflicting variables, common memory and CPU resources, and constraints on memory size create major debug nightmares if not carefully organized. Threads must be kept from altering each other's variables; threads that communicate must use a very strict protocol. Program threads in real time computing are usually short due to system and time constraints.

As the CPU and its multi-tasking thread count goes up, a real time operating system (RTOS) becomes more necessary. This software provides an orderly process for thread sharing and interrupt handling, a pre-designed and debugged handler that helps users to manage multiple operations with a minimum of interference between threads.

Interrupts that require the CPU to handle asynchronous events are especially hard to handle with distributed multiprocessing architectures. A new approach is required.

### Multiprocessing Architectures

Multiple CPUs can make a real time computing task simpler if related tasks can be organized as a decoupled set of program threads. The tradeoff is a more sophisticated communications mechanism between CPUs, which rapidly becomes unwieldy and sees diminishing returns as the number of CPUs increases. Software tasks must be carefully partitioned between CPUs; inter-CPU communication is hazardous from a debug standpoint because it creates vicious, randomly unrepeatable bugs.

In spite of these issues, Multiple CPUs are now commonly found on integrated circuits (here called ‘chips’, or devices). An SoC (system on chip) will typically assign several markedly different CPU-centric CPUs to differing major tasks. While this arrangement helps logically partition tasks and speeds up processing, debug of the portion of a system each CPU controls is best done separately whenever possible; however, at some point the CPUs must all be tested jointly.

### Processor Arrays

Graphic Processing Units (GPUs): GPUs and Systolic Arrays are used when massively parallel, regular computations are needed. Thousands of computational units with similar programs modify regularly arranged, largely parallel data computations. Throughput improvement sees diminishing returns as the number of computing elements goes up, especially with ill-defined problems or indeterminate program loops. Interrupts can become massively complex with these devices.

### Dataflow Architectures

Reduction of main memory accesses has been addressed using dataflow architectures. Data is fed serially and typically continuously through several computational devices, each performing a separate operation on the data, which is then returned to main memory after several operations. This approach is used by hardwired specialty computational engines (such as gate arrays, including field programmable gate arrays or FPGAs). In this regard, an FGPA that is specifically programmed to perform and implement the invention herein. Dataflow architectures in general are fast but also inflexible. Interrupts that attempt to use common hardware must deal with the interlocked, distributed nature of the programs.

### Interrupts

How are interrupts usually handled? During normal computation, CPU architectures use registers within the CPU for temporary data storage, main memory access, internal state maintenance, and data and program pointers. The contents of all these registers, the complete CPU state, is called here the computing context, or simply the context.

When an interrupt occurs, the CPU must store its entire current context on a special reserved set of memory locations (the interrupt stack) in a specific order. Then the CPU must jump to the interrupt handling routine and load a new interrupt context, compute the necessary response, then put away the interrupt context, restore the computing context from the stack in exactly the reverse order, and resume the interrupted program execution. Even the simplest CPUs take from 16 to hundreds of clock cycles to execute interrupt responses and return to the interrupted thread.

The time from the interrupt to the first instruction of the interrupt handling thread is the interrupt latency, which directly affects real time performance. The total of the time required to execute the entire interrupt call and return sequence is the interrupt overhead, also an important number because during that time the CPU is not available for other tasks or threads. In this discussion, interrupt overhead will not include the interrupt subroutine, for reasons that will become clear shortly.

### The Pipeline Problem

CPUs normally have internal instruction pipelines that allow instructions to be executed more quickly by working on several instructions in sequence. Longer internal pipelines generally speed up the CPU and allow more complex instructions to be executed. However, when an out-of-sequence event occurs, those same instruction pipelines become a temporal liability; they must be entirely dumped, or stored somewhere, before the unexpected event can be handled. Then, after the event is handled, the pipeline must be reloaded again to resume where the CPU left off. Time is lost refilling the pipeline again.

In dataflow architectures, it is not just a single CPU interrupted by the need to store context. The entire chain of CPUs in the architecture must be properly dealt with when the interrupt occurs.

### Multiple Interrupts

Consider what happens if multiple interrupts must be serviced by a CPU. If a program thread required to service one interrupt is excessively long, then additional interrupts that occur during that interrupt thread must wait for the interrupt thread to complete, in addition to adding their own latency to the interrupt overhead. Worse, it may be required to allow interrupts to interrupt interrupts because of the necessary response times. Under these conditions, computing performance drops precipitously, interrupt latency and overhead grow and response time grows accordingly.

For these reasons, it has been considered wise to make interrupt routines as short as possible. Typically, an interrupt will do nothing but store or send a single value, then signal the background software to start up a slower, interruptible program response thread to complete the required computations. The lag before that response thread starts adds to the total response time, which also decreases system performance even further.

A more sophisticated CPU requires more context to be stored. Interrupt latency and overhead performance is a cardinal and limiting attribute of real time computing. The RISC (reduced instruction set computing) versus CISC (Complex instruction set computing) debate was partly about this overhead issue. RISC machines make up for simpler instruction sets by lengthening the internal pipelined operations queue, which must be dealt with any time a branch or interrupt occurs; this adds to latency. CISC machines use more complex instructions to shorten the total program storage size, but can also increase the interrupt latency and stack storage timing when complex instructions are executed.

### Hardwired Logic

If CPUs cannot respond quickly enough, a hardwired custom logic design must be used. Solutions involve either a field programmable gate array (FPGA) or a custom logic design for volume applications. These designs are built using special hardware development languages, become very rigid, and require a completely different type of programming to build. However, because of the massive inefficiencies cited above, it is not uncommon to see a performance increase of 50 to 1 with hardware based interrupt handling. However, hardware designs add a great deal of complexity to system design.

There is a continuing need in all types of multi-CPU computing for better flexibility in functional partitioning and mapping, handling the computing context, and decreasing latency and overhead when an interrupt occurs. Faster CPU interrupt response times reduce the need for custom hardware-based solutions in high performance computing.

### The 3D Dataflow Architecture

In order to understand the interrupt structure and its advantages, we describe in this section a data movement architecture, distinguished by data movement (the data flow) through a series of CPUs rather than a single CPU operating repetitively on the data. This application refers to the computation CPU used in the architecture as a Reconfigurable Algorithmic Pipeline Core (“RAPC”) to distinguish this highly simplified computing unit from a standard CPU. This dataflow architecture is independent of the data path width and the type of computation done (for example, fixed or floating point computations). All data paths within the architecture are clocked synchronously by the transfer clock, Xclk. This application deals exclusively with Xclk in this discussion.

This architecture concentrates on making the RAPC as small and simple as absolutely possible. A large number of small RAPCs work sequentially, chained in a program thread, jointly producing data results as in an assembly line. Reducing the CPU size speeds it up, reduces cost and makes very fast interrupt response achievable.

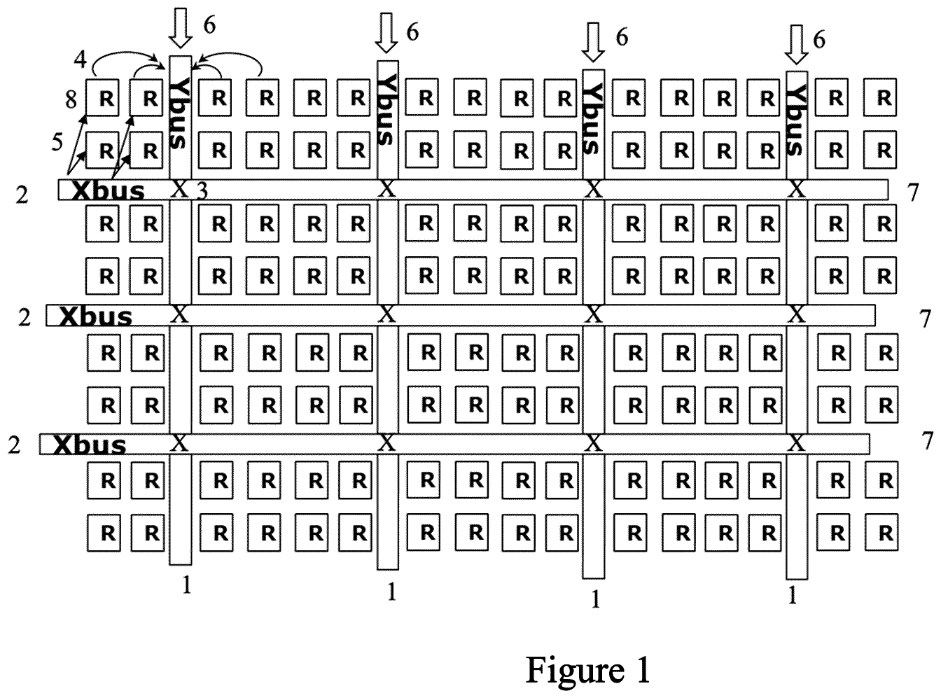

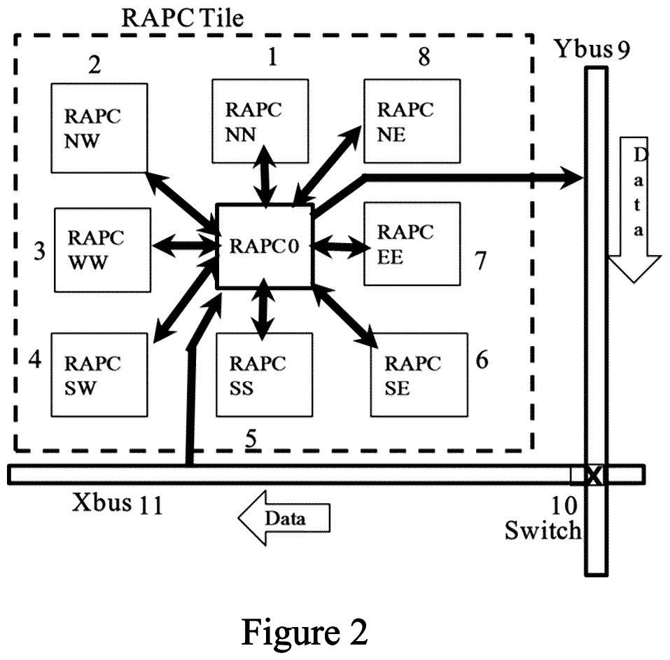

The architecture consists of a large number of RAPCs laid out in a regular XY array called a fabric (FIG. 1, labeled R) with multiple connections between adjacent RAPCs. In this example embodiment (FIG. 2), RAPC0 has bidirectional connections with RAPCs 1 through 8. A group of RAPCs is called a tile. All RAPCs in the fabric have the same communication network with all adjacent RAPCs.

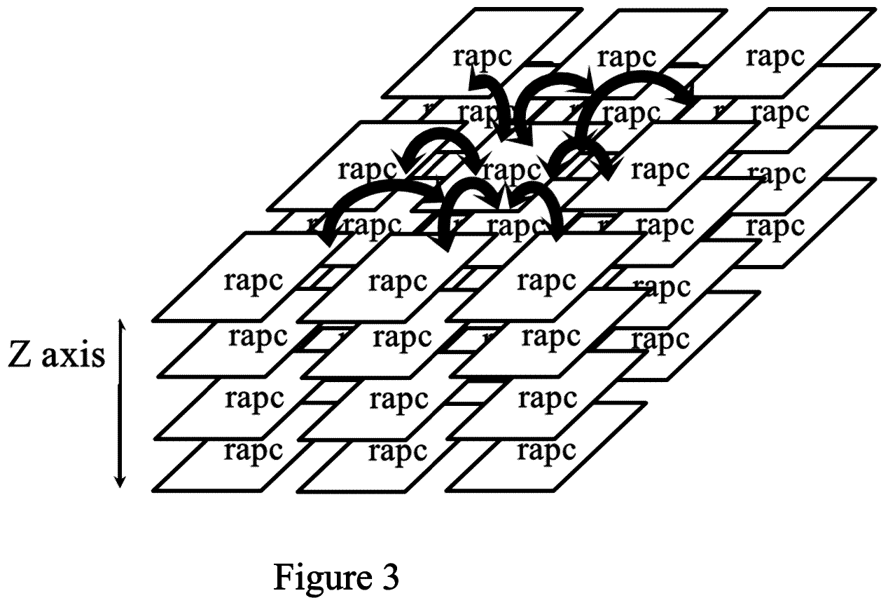

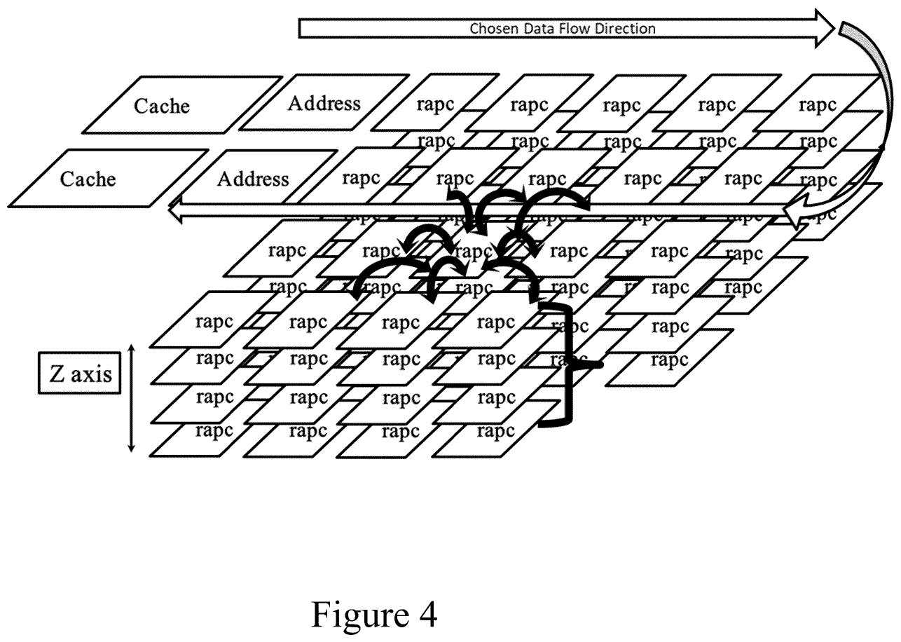

A metatag accompanies each data word throughout the matrix. The metatag is a priority number that indicates the relative importance of the data. This metatag is also treated as the third dimension of data movement, which the user treats as the Z axis (FIG. 3). A metatag Z value of 0 is the highest priority in this embodiment, while higher Z numbers indicate lower priority. This arrangement allows one RAPC to look like 4 or more virtual RAPCs to the programmer, as if they were stacked in layers (FIG. 4).

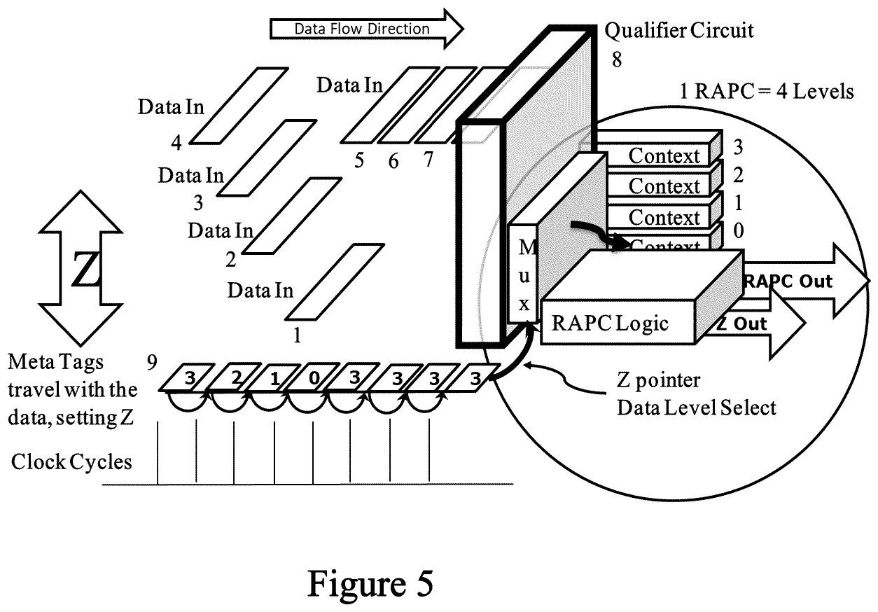

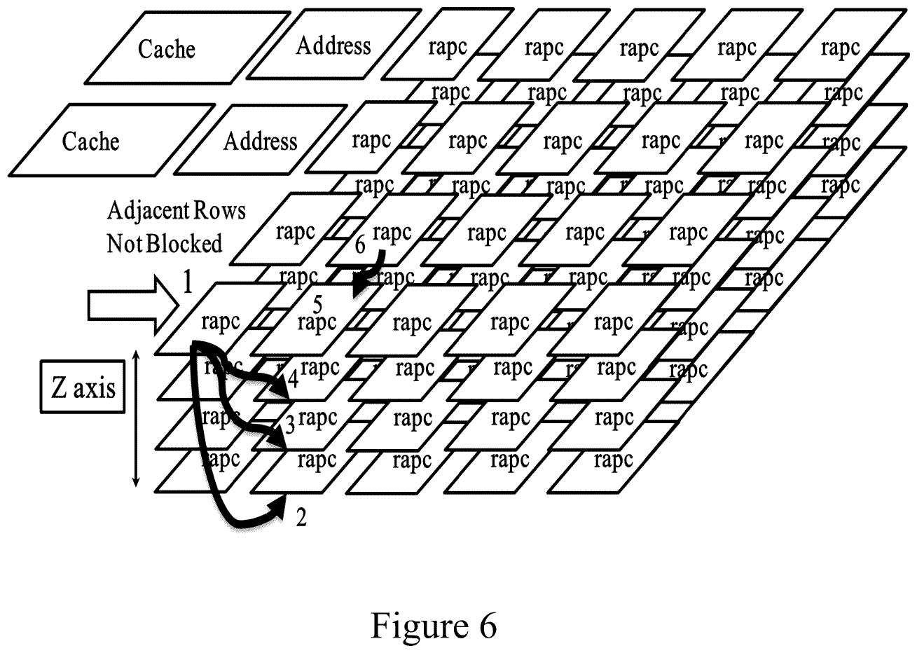

Each of the RAPCs in the fabric stores one complete independent computing context including one instruction for each Z value (FIG. 5). When data enters the RAPC, the metatag determines which computing context to use on the data. The internal multiplexer then chooses the proper context, the single operation is performed on the data, and the results and metatag are passed on to the output register. If desired, the metatag Z value can be changed in the RAPC to change the operation of the next RAPC in the sequence (FIG. 6). The ability to change Z levels allows data movement to be routed around bottlenecks on one layer by passing ‘over’ or ‘under’ the problem; branching can be handled by one RAPC even though 3 destinations are given by branching to a different Z level depending on the results of the computation. Further, the RAPC is not burdened with putting the data out to memory, eliminating the entire destination addressing structure.

In FIG. 6, the resulting programming model is shown. Program threads are usually stored in layers, each with a common metatag or Z value, much like a multi-layer printed circuit board.

### Source Addressing

Unlike a standard CPU, the RAPCs use source addressing. Each RAPC is programmed to watch for only 1 adjacent RAPC output register (the source or upstream device) for each argument needed. Each argument must also have a specific Z value for its computation.

Source addressing allows multiple RAPCs to respond to any output from an adjacent RAPC and perform the computation within a single transfer clock cycle. The data path is arranged by chaining the desired RAPC input sources to specific upstream sources, in sequence or in parallel.

With this arrangement the results of a single RAPC's computation can start multiple additional RAPCs to synchronously work with the results. The RAPCs need no data write instructions, and only use a 4 bit data source address field. There is no internal instruction pipeline or instruction fetch mechanism; only a single instruction is executed based on the metatag value before the results are passed on to the output register.

Branching (3D branch, FIG. 6) is accomplished by changing the metatag value, which has the effect of changing layers, or by having another RAPC in the XY matrix respond to the output register's contents. The illustrations show a 4 layer RAPC programming model, which uses a 2 bit metatag; there is only a small hardware penalty to using more layers.

### Data Collisions, Priorities and the Upstream Halt

It may be that more than one Z level calculation is requested of a given RAPC—or, not all the arguments arrive on the same clock edge. The RAPC can assert the upstream halt (Uhalt\) signal. Uhalt\ halts the pipeline upstream until valid data is received for all the required arguments. If, for example, more than one argument is needed but only 1 has arrived, the RAPC asserts Uhalt\ for the data that has arrived, preventing it from being overwritten until the rest of the missing arguments all arrive.

Also, if a higher priority algorithm needs to use a given RAPC, the Uhalt\ signal of that RAPC is asserted for lower priority datapaths, until the higher priority block is finished.

Each RAPC operation typically uses more than one argument, each of which may have its own upstream datapath. The RAPC sends Uhalt\ to each upstream RAPC that has supplied an argument, until all required operands are present. If at least one downstream RAPC asserts Uhalt\, the RAPC echoes Uhalt\ to each upstream RAPC in the data path that has provided data.

### Control and Timing

### Input/Output Driven RAPC Fabric

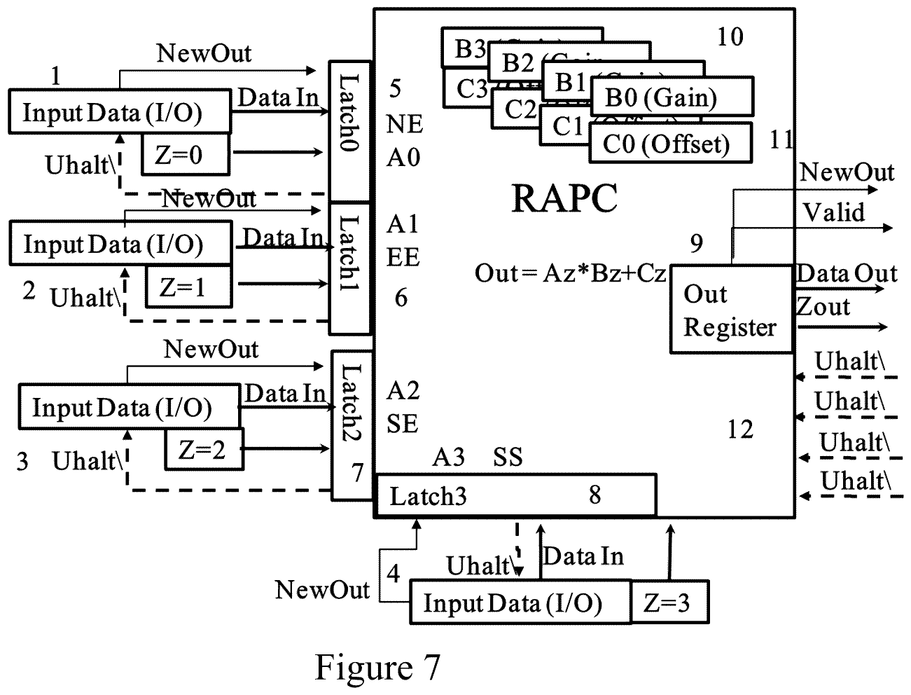

Interrupts typically come from external sources. In FIG. 7 a RAPC is set up to receive data from several exterior inputs, such as analog to digital converters or resolvers, which have high data rates. The inputs and outputs are configured as if they are adjacent RAPCs. The RAPC receives data to input registers 1 through 4. For all 4 identical inputs, the corresponding incoming NewOut signal latches the data into an input latch of the RAPC. In this particular case, the input channels NE 5, EE 6, SE 7 and SS 8 are pre-programmed to recognize Z values from 0 to 3 to establish the priority and prevent data collisions. External data is brought in as the A argument (A0 through A3, 5 through 8).

The typical 10 or 12 bit unsigned binary data is multiplied by gains B0 through B3 from the internal registers. Then an offset (C0 through C3), also stored in internal registers, is added to convert the value to signed binary. The output register 9 then receives the result.

### Interrupt Structure

We now disclose the interrupt architecture and its advantages.

### Interrupt Circuitry

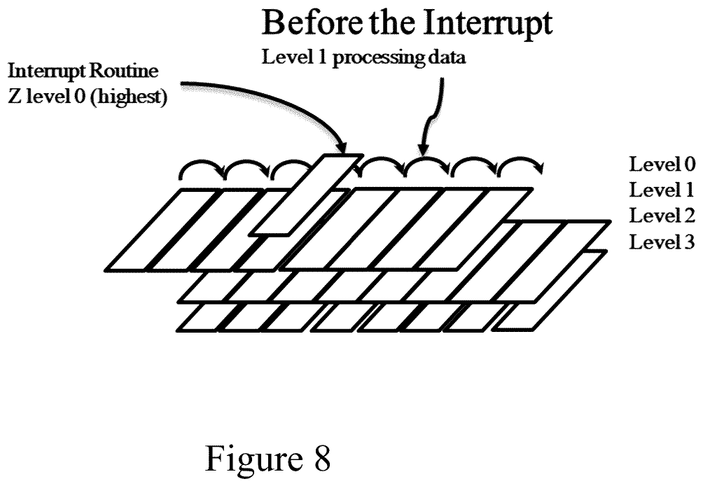

The RAPC interrupt response is easiest to understand if we look at the pipelined dataflow process of FIG. 6 and superimpose an interrupt on the 3D abstracted programming model (FIG. 8 through FIG. 12). Interrupt dataflow operation is described by representing RAPCs as simple rectangles. Each rectangle represents a single operation and a single Xclk cycle.

In FIG. 8 the 3D programming model is shown during normal operation before an interrupt occurs. Normal dataflow is proceeding through the dataflow matrix from left (upstream) to right (downstream) on level 1 (second level). Level 0 (top) is reserved for interrupts, and is waiting for an interrupt to occur. Remember that each RAPC corresponds to a vertical stack of 4 rectangles; each RAPC handles all 4 levels of computation. The rectangle corresponding to the first interrupt routine in this embodiment has one port configured as a hardware configured RAPC. Data from this block must be processed by an interrupt routine, which is installed in Z layer 0 because of its high priority. Four computational steps are needed to process the data completely. So four successive RAPCs also have level 0 dedicated to interrupt handling (not shown, for clarity of level 1 operations).

### Interrupt Operation

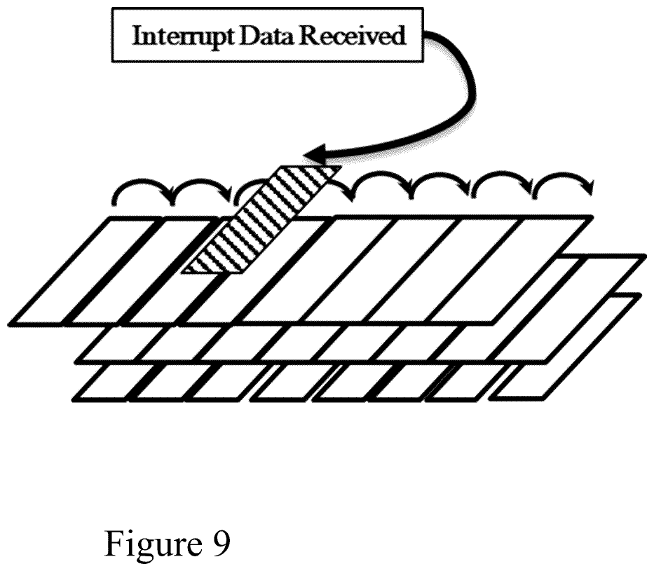

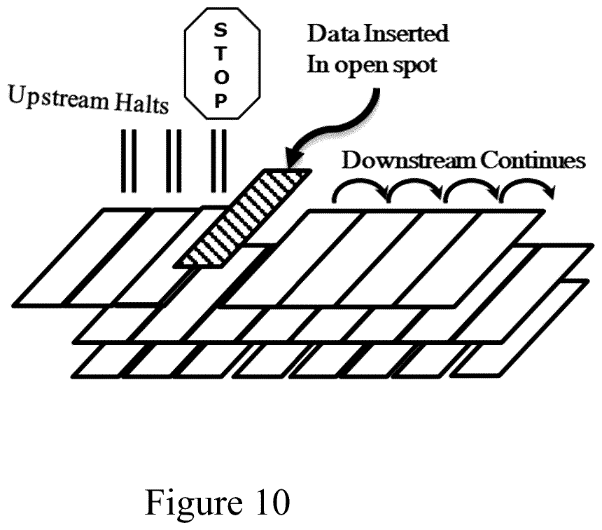

In FIG. 9 an interrupt occurs. The I/O configured RAPC responds to Z level 0 input from the external hardware in FIG. 10; the Upstream Halt is asserted. Upstream calculations are halted, while downstream calculations and data movements continue. A 1 clock cycle space in the dataflow stream opens up. During this time period, the interrupt data is processed by the RAPC that received the data, and inserts it in this data stream, in this newly opened RAPC computational space (FIG. 10). The I/O configured RAPC assigns the data a Z level of 0, setting its priority to be processed with level 0 dataflow contexts.

The upstream halt is de-asserted (turned off) on the next cycle, so that normal background dataflow continues on the next Xclk; downstream data has flowed to the right one RAPC.

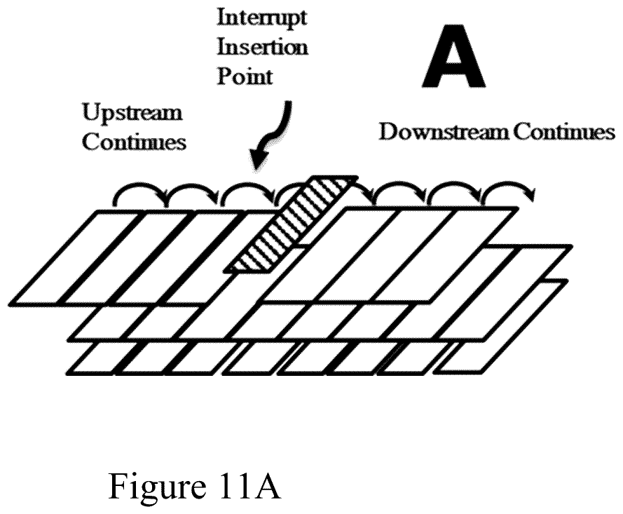

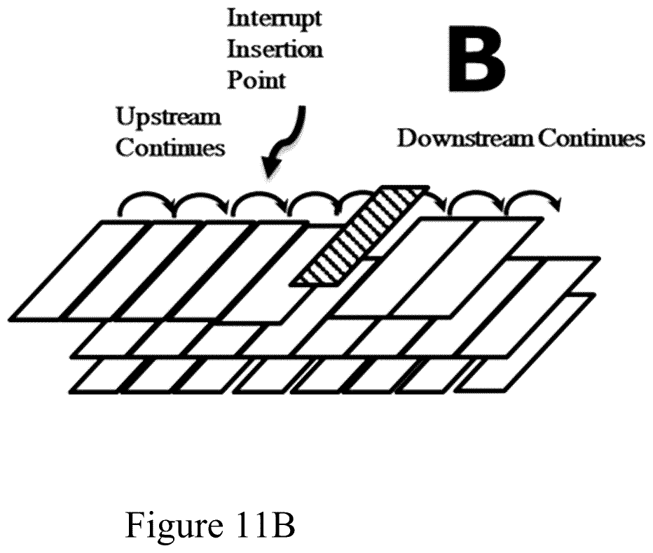

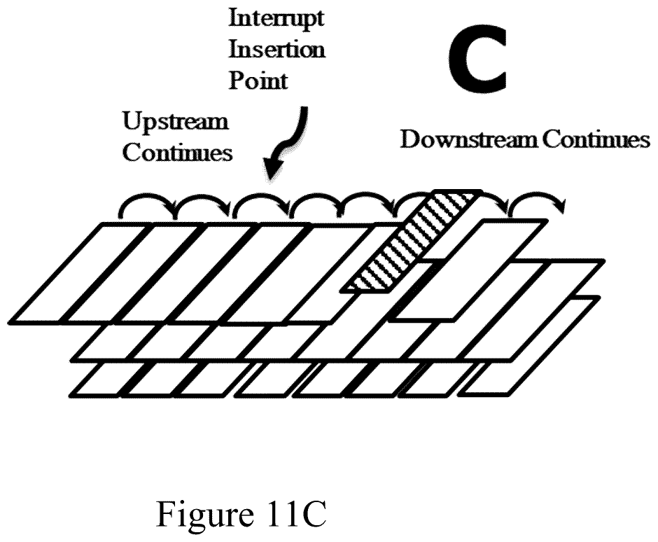

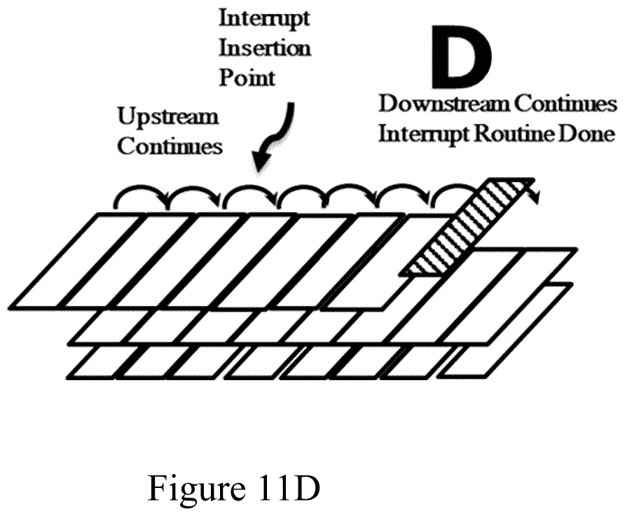

In FIGS. 11A, B, C, D we see 4 successive Xclk cycles. On each cycle, the interrupt data moves one RAPC to the right along with the already established data flow. Each RAPC in the downstream sequence responds to the interrupt meta tag and processes the data in the subsequent steps required to process it with the interrupt algorithm. Then, each RAPC returns to processing the level 1 data on the very next Xclk cycle.

Analyzing the results thereof:

1. The input configured RAPC processed the data during the first Xclk cycle. So the interrupt latency is a single clock cycle long.

2. The interrupt data has been processed on level 0, using 4 clock cycles. One could say the interrupt overhead was 4 cycles (4 computations plus the response cycle), but this is misleading because this is a multi-CPU system. The calculations being performed on Z Level 1 lost only a single clock cycle of computation time. This holds true regardless of the number of cycles used by the interrupt processing. From the standpoint of the background routines, then, the interrupt overhead (the amount of time lost from the level 1 computations) is still one cycle, regardless of the interrupt length, because only 1 RAPC at a time handles the interrupt thread, using only 1 Xclk cycle to do its small share in the thread. Regardless of the number of clock cycles required to execute the interrupt response routine, the other currently running threads only lose a single clock cycle, a non-obvious and very useful improvement. Calculation timing for both the interrupt routine and the background (level 1) threads are therefore nearly constant (flat), regardless of the number of interrupts received, within the limits of the Z level processing context.

3. The Uhalt\ hardware automatically compensates for the timing insertion. The downstream RAPCs can compensate for lost cycles and timing changes, and keep timing synchronous if necessary by waiting for valid data on all other data paths that bring additional arguments to the calculation.

4. The resulting output from the interrupt routine is marked by its accompanying meta tag, which has a Z level of 0 in it. Subsequent RAPCs can distinguish between the two independent data stream outputs by the Z level that accompanies the data. The number of clock cycles inserted can also be measured by counting the number of interrupts, by counting the upstream halts, by counting the number of data with a Z level of 0, or a number of other approaches.

5. The interrupt routine is completely executed on level 0. There is no need to wait for a convenient time to deal with the data and start and synchronize an auxiliary thread. Interrupt routines can be much longer because processing time has been reduced without the overhead of context storage and retrieval, further reducing response time and the overhead required for interrupt servicing. The need to enable and synchronize additional, lower priority threads in the program to finish calculations elsewhere is eliminated. The conventional ‘stringing together’ of two levels of interrupt processing with its necessary coordinating headaches is completely avoided.

Alternatively, the RAPCs adjacent to the input RACP in other rows and columns can be programmed to respond to the interrupt on level 0, which can also start additional fully synchronous response threads in adjacent rows. If additional interrupt processing is needed, several adjacent RAPC threads can be synchronously started, with similar low or zero impact on normal data flow.

We now contrast this arrangement with a conventional interrupt structure. What has not been necessary:

There is no need for an interrupt stack or the corresponding ‘return from interrupt’ routines. The computing context is always locally stored at all times, part of the design of every RAPC. The 3D architecture automatically restores the background processes without a timing penalty. Elimination of context storage and retrieval reduces total response time of the entire system.

There is no need for timing isolation, because interrupt timing (here on level 0) and main data timing (shown here as level 1) interact by only 1 Xclk cycle regardless of the length of the algorithm on either level. Very little impact occurs on the main data flow is also seen on the interrupt data flow, which is affected minimally by actions in the level 1 (main) calculations. This fact keeps timing related bugs (among the worst kind to find) to a minimum.

There is no need to mask interrupts to prevent disruption of critical operations. Each interrupt input has multiple complete dataflow paths available even if a single RAPC handles multiple interrupts.

There is no data logjam at the interrupt data input. It is less obvious that interrupts from the same source also have constant response time and computation time, because data moves away from the RAPC that received it. Further, like all other 3D threads, the interrupt routine can easily be made reentrant in nature (meaning that currently processing data doesn't have to be completed before new data enters the thread) because each RAPC is isolated from the preceding upstream RAPC. Interrupts can come in almost at the clock rate and still be processed.

A big advantage of this approach, then, is flat, very fast and very consistent interrupt timing, nearly independent of the multiplicity of threads executing at any given time, and nearly independent of the number of threads required to respond to the interrupt.

Since each interrupt can be assigned a different Meta level (Z level) which automatically separates the interrupt data from normal program flow, there is a greatly reduced need for an RTOS software system to be used.

### Multiple Interrupts

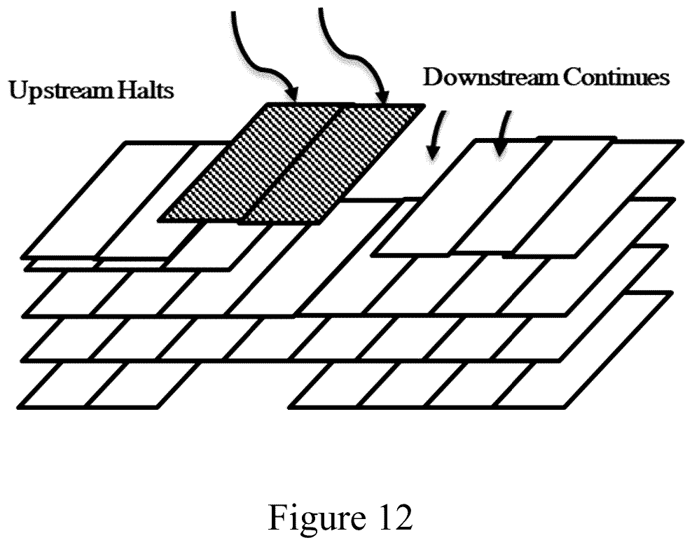

If 2 interrupts are to be handled, the same RAPC can be assigned to handle each interrupt on a different Z level, as long as the remaining Z levels are free from being occupied by background processes (FIG. 12). The Z level priority structure built into the RAPC also becomes the priority structure for the Interrupts. The time penalty for the lower priority thread is one Xclk cycle per interrupt level.

Priorities can also be adjusted. For instance, if an ‘uninterruptible computation’ needs to ignore interrupts, that computation can run on level 0, while levels 1 and/or 2 handle the interrupt(s) as time permits.

### Advantages when Using Multiple Interrupts

Additional advantages of this structure now become evident.

Each additional interrupt handled by the same RAPC adds at most 1 Xclk cycle of latency to the response.

If that one additional cycle response is still a problem, multiple RAPCs can be used to keep response at a single clock cycle.

The single cycle context switching guarantees that as long as different Z levels or adjacent RAPC rows are used to respond to the interrupts, all data is kept completely separate (a property known as encapsulation). No interrupt cross-data interferences occur.

Interrupt response jitter, caused in typical CPUs by variable context storage times, overlaid or daisy chained interrupts, and the like, is reduced to a single cycle at the clock rate, plus potentially an additional cycle per layer if multiple interrupts are handled by the same RAPC. This is an important advantage for sampled data systems.

Total interrupt overhead is drastically reduced by these additional factors:

It is no longer necessary to worry about ‘interrupts interrupting interrupts’. In this embodiment, the answer is clearly, ‘yes we can’. But now the question is nearly meaningless. The response times and calculation delays are no longer significantly impacted by the arrival of additional interrupts. It is highly unlikely, given the greatly faster timing and single cycle processing, that any interrupt would be interrupted by any other interrupt. If even this response time is too slow, using a separate RAPC for each interrupt can be employed to keep the timing low.

Since the interrupt circuitry also passes a meta tag, the response can be vectored to other specific response routines from a single input. By using multiple RAPCs and/or multiple levels, an arbitrarily prioritized, vectored interrupt response with fully parallel computation for the calculations is achievable with no additional hardware.

### Timing Margins

Because of the overhead associated with interrupts in standard architectures, it is common for CPU-centric or real time CPU systems to dedicate no more than 65% of their available time to interrupt servicing. If interrupt service routines take up more than this, the chances of missed interrupts, painfully long response or complex bugs is greatly increased. Since in this architecture service routines are short, distinct and have their own service CPUs, interrupt latency margin requirements that other computing structures require are eliminated. These margin elimination improvements add substantially to the actual computing capability of the 3D architecture without adding hardware.

### Usage in Non-dataflow or XY Only Data Systems

The use of this interrupt architecture does not require XYZ structures external to it to achieve its purpose. The multiple context Z dimension need only be true within the RAPC that takes the data in, to avoid the need to switch context and improve latency. The number of Z dimension levels should be ideally equal to or greater than the number of interrupts expected in the first assigned RAPC.

If all the interrupt does is receive or send pre-configured data, then the only RAPC that must have the same Z level count is the RAPC that receives or sends the data.

The number of Z levels of subsequent computing elements should be enough to allow completion of the required distinct interrupt computations.

The alternative is to store context for the data displaced, for each computational block past the edge of the computational area.

The 3D architecture thus also proves to be a valuable addition to conventional CPUs as an ‘interrupt handling architecture’.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A low overhead interrupt system comprising:
a plurality of Reconfigurable Algorithmic Pipeline Cores (“RAPCs”), wherein each RAPC is configured to receive data based on:
sources that provide the data;
a meta tag that travels with the data;
synchronization information;
wherein each RAPC is further configured to execute a single instruction selected based on that source;
wherein a selected RAPC is configured to respond to an interrupt within a single transfer clock cycle;
wherein each RAPC is further configured to perform a single data operation on the data and halt upstream computations to form a timing opening in the dataflow computing stream without requiring momentary storing or restoring of the computing context.

2. The interrupt system of claim 1 wherein:
the selected RAPC is configurable to insert the data and assign metatag, after processing of the metatag, into the timing opening in the dataflow computing stream; and
a multi-level 3D computing architecture of the RAPCs is configurable to process the data, the plurality of RAPCs being configurable to be chained in a sequence in such a manner as to execute a multiple cycle computational algorithm without requiring context storage by passing data down the sequence chain.

3. The system of claim 1 wherein the opened window in the dataflow computing stream is the only effect on the timing of the background dataflow timing.

4. The system of claim 1 wherein the selected RAPC is configured to, for each input, according to its metatag priority, without requiring momentary storing or restoring of the computing context:
accept multiple inputs and perform a single operation on each data input based on its source;
assign a priority metatag to each data input; and
pass the data downstream with the assigned metatag.

5. The system of claim 1, wherein the selected RAPC is configurable to pass the data to at least one downstream RAPC, wherein each downstream RAPC is configurable to: perform one selectable operation on the interrupt data according to the metatag and perform another operation according to a completely different metatag on the following clock cycle without requiring momentary storage or restoring of the computing context.

6. The system of claim 1, wherein the system is a field programmable gate array (FPGA) specifically programmed to perform the configurations of the RAPCs.
